(19) United States
(12) Patent Application Publication
(10) Pub. No.: US 2017/0210230 A1
(43) Pub. Date: Jul. 27, 2017

(54) ELECTRICAL INSTALLATION HAVING HIGH AND LOW VOLTAGE CIRCUITS WITH COMMON GROUND REFERENCE

(71) Applicant: E-TRACTION EUROPE B.V., Apeldoorn (NL)

(72) Inventor: Jorrit Job HEUSINKVELD, Arnhem (NL)

(21) Appl. No.: 15/329,327

(22) PCT Filed: Jul. 27, 2015
(86) PCT No.: PCT/NL2015/050549

§ 371 Date: Jan. 26, 2017

(30) Foreign Application Priority Data
Jul. 28, 2014 (NL) 2013271

(51) Int. Cl. B60L 3/00; H02J 3/00

(52) U.S. Cl. CPC B60L 3/0069; H02J 3/005; B60L 3/0046

(57) ABSTRACT

An electrical installation includes a high voltage power source having a first ground reference, and a low voltage power source having a second ground reference (21). A power unit of the electrical installation receives power from the high voltage power source and is conductively connected to the first ground reference. The installation also includes one or more peripheral units. At least one of the peripheral units receives power from the high voltage source and is conductively connected to the first ground reference. The first ground reference is galvanically isolated from the second ground reference. The power unit may include a motor drive for driving an electrical motor and may be installed in a vehicle.

### FIELD OF THE INVENTION

The invention relates to an electrical installation comprising a high voltage power source having a first ground reference, a low voltage power source having a second ground reference, a power unit receiving power from the high voltage power source and being conductively connected to the first ground reference, and one or more peripheral units receiving power from the low voltage power source.

### BACKGROUND OF THE INVENTION

Such electrical installations are generally applied and have the power unit connected to the high-voltage power source and the associated first ground reference, and have the peripheral units connected to the low voltage power source and associated second ground reference. To exchange signals between the two units their signal lines have to be electrically isolated in between units of which one unit has a high voltage ground reference and the other unit has a low voltage ground reference. An isolation barrier therefore needs to be present between these two units. Implementing isolation barriers in electrical installations can be quite cumbersome.

Further, a drive, such as a motor drive, powered by and/or comprised in the power unit is susceptible to common mode interference in the signal lines to the drive. This may cause erroneous responses by the drive and requires complicated circuitry for suppressing the common mode interference.

### SUMMARY OF THE INVENTION

It is an objective of the invention to provide an electrical installation having high and low voltage power circuits with a reduced or minimum number of isolation barriers.

It is another or alternative objective of the invention to provide an electrical installation having high and low voltage power circuits with less sensitivity to common mode interference, especially of a connected drive.

It is yet another or alternative objective of the invention to provide an electrical installation having high and low voltage power circuits with less sensitivity to common mode interference of a connected motor drive.

At least one of the above objectives is achieved by an electrical installation comprising a high voltage power source having a first ground reference, a low voltage power source having a second ground reference, a power unit receiving power from the high voltage power source and being conductively connected to the first ground reference, and one or more peripheral units, wherein at least one of the peripheral units receives power from the high voltage power source and is conductively connected to the first ground reference.

In a preferred embodiment the first ground reference is galvanically isolated from the second ground reference to prevent electrical connection between both ground references.

In an embodiment the power unit comprises an electric motor drive, and in a further embodiment the power unit comprises an in-wheel electric motor drive. Especially when powering an electric motor one would like to prevent common mode interference and implementation of multiple isolation barriers.

In yet a further embodiment the electrical installation is installed in a vehicle, in which all surfaces that may contact a person during use of the vehicle can be galvanically isolated from the high voltage power source. Especially in a vehicle one would prefer to have no common mode interference for a proper and reliable functioning of the vehicle and a minimum of isolation barriers for safety and reliability purposes.

In an advantageous embodiment the vehicle comprises a metal chassis or metal subframe, and the second ground reference comprises the metal chassis or metal subframe. In a further advantageous embodiment the vehicle comprises a metal subframe and the second ground reference comprises the metal subframe, the vehicle further comprising a body of a non-conductive construction. The metal chassis or subframe proved to be reliable and safe for use as the second ground reference. Having a non-conductive body of the car prevents contact of the driver or user with conductive and electrically connected parts of the car.

In another embodiment the high voltage power source comprises a high voltage battery pack having a positive pole and a negative pole, and the first ground reference comprises the negative pole of the battery pack. Such battery pack effectively provides for the high voltage and storage of electrical energy.

In an embodiment the high voltage power source may have an operating voltage in the range of from 300 Volts to 600 Volts, more preferably to 1000 Volts, optionally up to 2000 Volts. In other embodiments the low voltage power source may have an operating voltage in the range of 8-Volts to 48 Volts.

In an advantageous embodiment the electrical installation comprises a communication unit receiving power from the low voltage power source and being conductively connected to the second ground reference, in which the communication unit can comprise a dashboard display. Since the communication unit, and especially a display of the communication unit, will be installed in a users area is proves to be safer to have it conductively connected to the second ground reference.

In another aspect the invention provides for a kit comprising components of the electrical installation according to the invention. The kit may be for installation in a vehicle.

### BRIEF DESCRIPTION OF THE DRAWINGS

Further features and advantages of the invention will become apparent from the description of the invention by way of non-limiting and non-exclusive embodiments. These embodiments are not to be construed as limiting the scope of protection. Various other embodiments can be envisioned within the scope of the invention. Embodiments of the invention will be described with reference to the accompanying drawings, in which like or same reference symbols denote like, same or corresponding parts, and in which

FIGS. 1, 2, 3, 4 and 5 show schemes of first, second, third, fourth and fifth embodiments, respectively, of an electrical installation according to the invention; and

FIG. 6 shows a car comprising an electrical installation according to the invention.

### DETAILED DESCRIPTION OF EMBODIMENTS

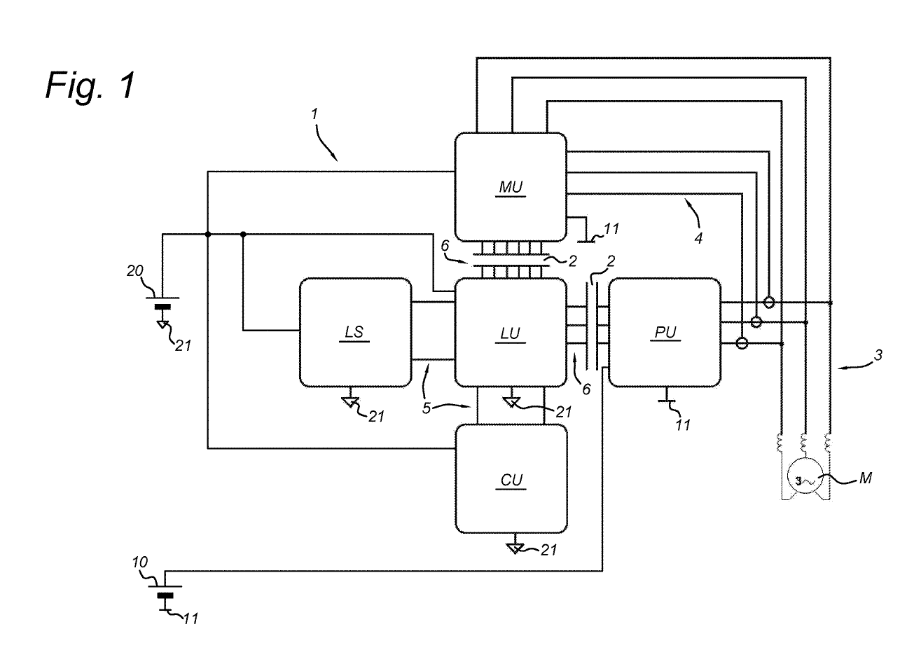

A scheme of a first embodiment of an electrical installation 1 according to the invention is shown in FIG. 1 and comprises a high voltage power source 10 with a first ground reference 11, and a low voltage power source 20 with a second ground reference 21. The high voltage power source 10 is connected to a power unit PU having a motor drive for driving a 3-phase motor M over power lines 4 in the embodiment shown. Power unit PU is connected to the first ground reference 11 associated with the high voltage source 10.

A measurement unit MU measures power levels in the power lines 3 using signal lines 4. The measurement unit MU is powered by the low voltage power source 20 but is not connected to the associated second ground reference 21. Instead measurement unit MU is connected to the first ground reference 11 associated with the high voltage power source 10.

The electrical installation of the FIG. 1 embodiment further comprises a logic unit LU for evaluating logic signals, a logic supply unit LS for determining logic indicator signals based on various inputs that are not further shown in the figure, and a control unit CU that provides a means for a user or driver to provide input into the system and to be provided with feedback signals from the system. The units LU, LS and CU are all powered by the low voltage power source 10 and connected to the second ground reference 21 associated with the low voltage power source 20. Accordingly, isolation barriers 2 are present in the signal lines 6 between logic unit LU on the one hand and measurement and power units MU and PU on the other hand. The first ground reference 11 is galvanically isolated from the second ground reference 21. The signal lines 5 between units LS, LU and CU do without isolation barriers since all these units are connected to the same ground potential.

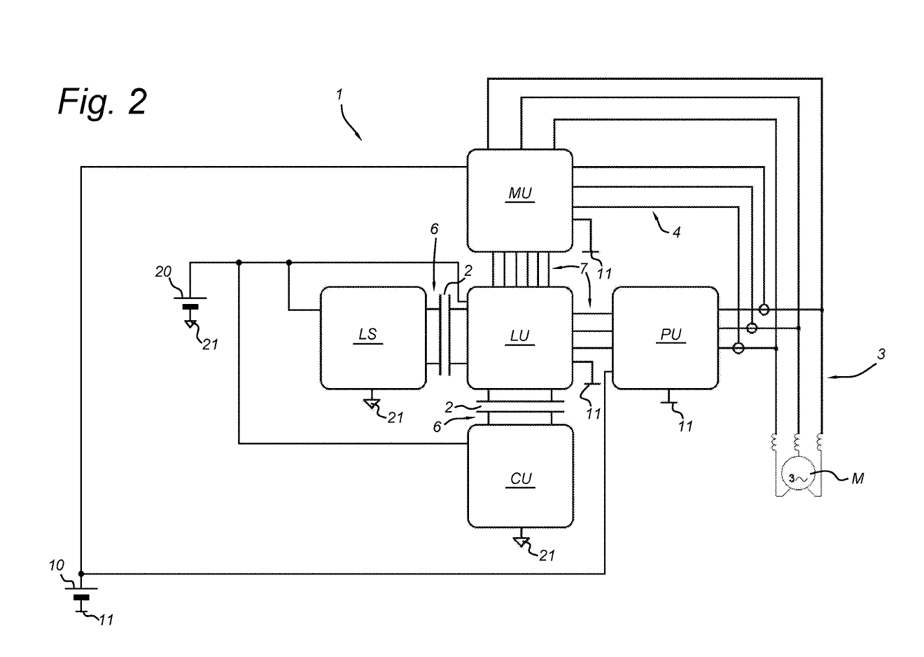

A second embodiment of an electrical installation 1 according to the invention is shown in FIG. 2. The second embodiment largely resembles the first embodiment of FIG. 1, but measurement unit MU is powered by high voltage power supply 10 and logic unit LU is connected to the first ground reference 11. All three units PU, MU and LU are thus connected to the first ground reference. Any signal lines or electrical connections 4, 7 between the units PU, LU and MU can therefore do without isolation barriers. Units PU and MU are powered by high voltage power source 10, and units LU, LS and CU are powered by low voltage power source 20.

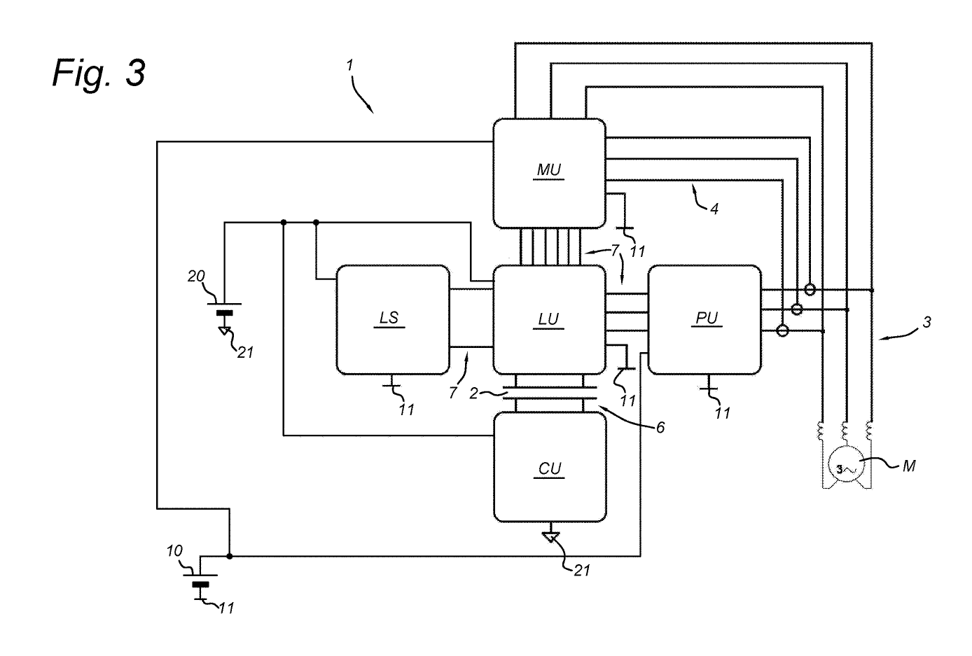

A third embodiment of an electrical installation according to the invention is shown in FIG. 3. It largely resembles the second embodiment of FIG. 2. However, in the third embodiment units LS and HVF are electrically connected to first ground reference 11. Power unit PU and measurement unit MU are powered by high voltage power source 10, and all other units LU, CU, LS and HVF are powered by low voltage power source 20. Only communication unit CU is electrically connected to second ground reference 21 associated with the low voltage power source 20. Therefore, only the electrical connections 7 between communication unit CU and the logic unit LU comprise an isolation barrier 2 since both units are connected to different ground references, being the second and first ground references 21, 11, respectively.

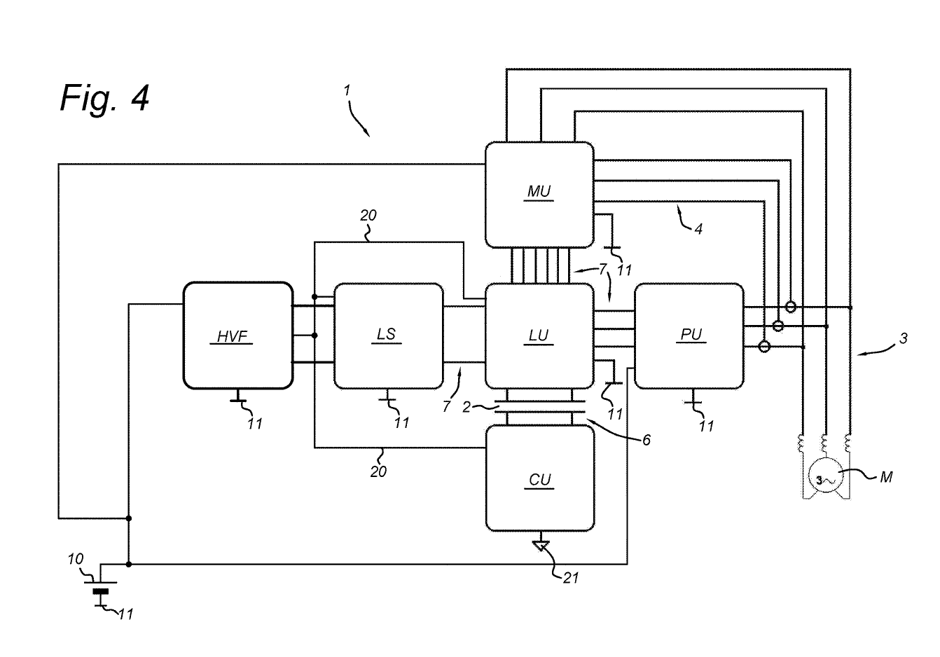

A fourth embodiment of an electrical installation according to the invention is shown in FIG. 4. It largely resembles the third embodiment of FIG. 3. However, the fourth embodiment additionally comprises a high-voltage flyback unit HVF exchanging electrical signals with unit LS through electrical or signal lines 7. The high-voltage flyback unit HVF is connected to high-voltage power source 10 and converts a high voltage into a low voltage. The low voltage provided by the flyback unit acts as a low-voltage power source for the units LS, LU and CU and is provided over voltage lines 20. A description of a flyback unit is provided in Dutch application number 2012027, which is incorporated herein by reference.

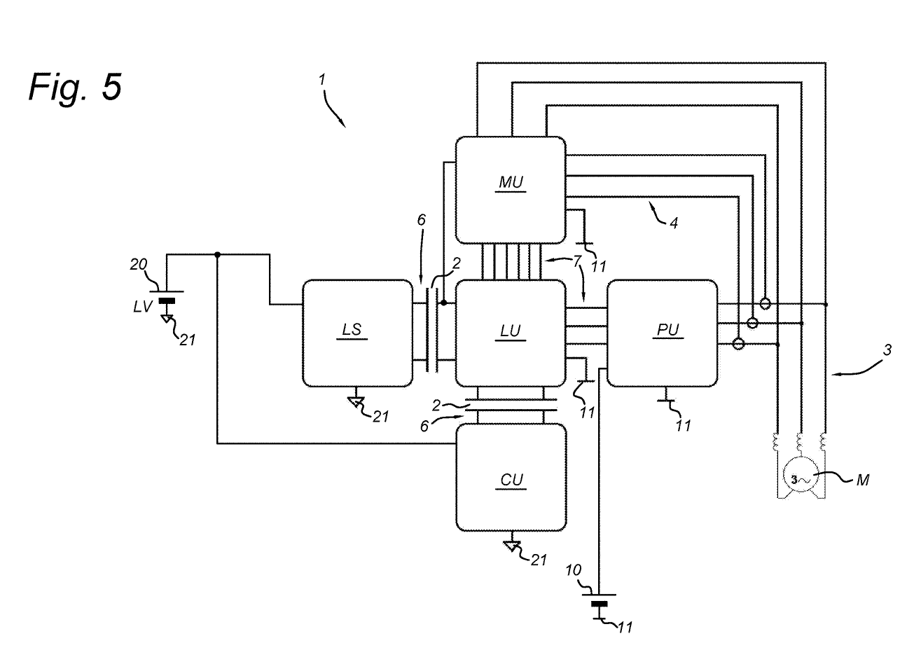

FIG. 5 shows a fifth embodiment of an electrical installation according to the invention. It is largely identical to the embodiment of FIG. 2. However, measurement unit MU and logic unit LU are connected over a galvanic isolation to a low voltage supplied through logic supply unit LS.

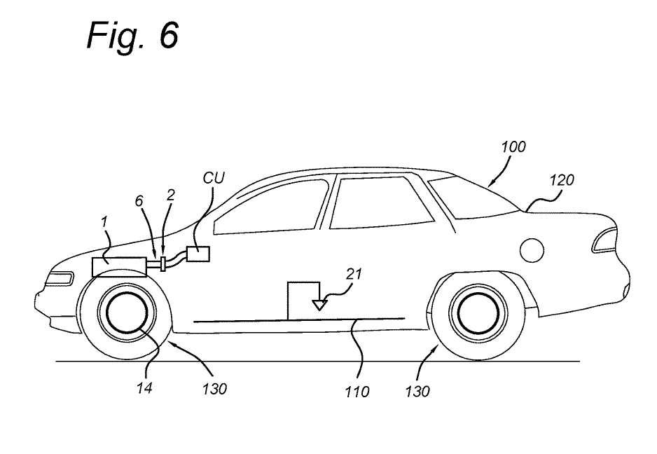

A vehicle 100 having an electrical installation 1 according to the invention is depicted in FIG. 6. The vehicle shown especially comprises an electrical installation according to the third embodiment, of which the communication unit CU and electrical connections 6 and their isolation barrier 2 are shown separately in FIG. 4. In alternative embodiments of the vehicle 100, the electrical installation may be according to the first or second embodiments of the electrical installation 1 or according to any other feasible embodiment of the electrical installation 1 according to the invention.

The vehicle or car 100 has wheels 130 that are each provided with an in-wheel electrical motor M for moving the car 100. An in-wheel electrical motor is, for instance, disclosed in WO 2001/054939. The motor is powered by a motor drive that is incorporated in the power unit PU of the electrical installation 1. The vehicle 100 has a metal chassis or subframe 110 that is connected to the electrical installation 1 such that the second ground reference comprises the metal chassis or subframe. The vehicle further has a body 120 of non-conductive construction that comprises materials that are electrical isolators. The measurement unit MU determines operating parameters of the power unit PU. It receives power from the high voltage power source 10 and is conductively connected to the first ground reference 11.

A display of the communication unit CU is arrange in the dashboard of the vehicle to display data to the driver and optionally to receive input from the driver and to pass the input to the logic unit LU. The communication unit CU is conductively connected to the second ground reference 21. All components of the electrical installation are arranged such that any surfaces that may come into contact with a person during use of the vehicle are galvanically isolated from the high voltage power source 10.

The high voltage source 10 comprises a high voltage battery pack. The first ground reference 10 comprises the negative pole of the battery pack. The positive pole of the battery pack is connected to the units PU and MU for powering these units. The operating voltage of the high voltage power source is in the range of 300 to 600 Volts, but the upper range may is preferably 1000 Volts and optionally 2000 Volts. The low voltage power source 20 has an operating voltage in the range of 8 to 48 Volts.

A vehicle can be provided with the electrical installation 1 disclosed during manufacture of the vehicle. However, it may also be provided as a kit comprising components of the electrical installation such that it can be retrofitted into a vehicle.

1. An electrical installation (1) comprising a high voltage power source (10) having a first ground reference (11), a low voltage power source (20) having a second ground reference (21), a power unit (PU) receiving power from the high voltage power source (10) and being conductively connected to the first ground reference (11), and one or more peripheral units (MU, LU, LS, HVF, CU), wherein at least one of the peripheral units (MU, LU, LS, HVF, CU) receives power from the high voltage power source (10) and is conductively connected to the first ground reference (11).

2. The electrical installation claim 1, wherein the first ground reference (11) is galvanically isolated from the second ground reference (21).

3. The electrical installation of claim 1, wherein the power unit (PU) comprises an electric motor drive.

4. The electrical installation of claim 3, wherein the power unit (PU) comprises an in-wheel electric motor drive.

5. The electrical installation of claim 1, which is installed in a vehicle (100).

6. The electrical installation of claim 5, wherein all surfaces that may contact a person during use of the vehicle are galvanically isolated from the high voltage power source (10).

7. The electrical installation of claim 6, wherein the vehicle (100) comprises a metal chassis or metal subframe (110), and the second ground reference (21) comprises the metal chassis or metal subframe.

8. The electrical installation of claim 7, wherein the vehicle (100) comprises a metal subframe (110) and the second ground reference (21) comprises the metal subframe, the vehicle further comprising a body of a non-conductive construction (120).

9. The electrical installation of claim 1, wherein the high voltage power source (10) comprises a high voltage battery pack having a positive pole and a negative pole, and the first ground reference (11) comprises the negative pole of the battery pack.

10. The electrical installation of claim 1, wherein the high voltage power source (10) has an operating voltage in the range of from 300 Volts to 2000 Volts.

11. The electrical installation of claim 1, wherein the low voltage power source (20) has an operating voltage in the range of 8 Volts to 48 Volts.

12. The electrical installation of claim 1, comprising a communication unit (CU) receiving power from the low voltage power source (20) and being conductively connected to the second ground reference (21).

13. The electrical installation of claim 12, wherein the communication unit (CU) comprises a dashboard display.

14. A kit comprising components of the electrical installation (1) of claim 1.

15. The kit of claim 14 for installation in a vehicle.

16. The electrical installation of claim 10, wherein the high voltage power source (10) has an operating voltage in the range of from 300 Volts to 600 Volts.

17. The electrical installation of claim 10, wherein the high voltage power source (10) has an operating voltage in the range of from 300 Volts to 1000 Volts.

18. The electrical installation of claim 2, wherein the power unit (PU) comprises an electric motor drive.

19. The electrical installation of claim 2, which is installed in a vehicle (100).

20. The electrical installation of claim 3, which is installed in a vehicle (100).
